(19) United States
(12) Patent Application Publication
(10) Pub. No.: US 2015/0190831 A1
(43) Pub. Date: Jul. 9, 2015

(54) DRY ETCHER AND ETCHING METHOD OF THE SAME

(71) Applicant: Shenzhen China Star Optoelectronics Technology Co., Ltd., Shenzhen, Guangdong (CN)

(72) Inventor: Siyang Liu, Shenzhen (CN)

(21) Appl. No.: 14/238,733

(22) PCT Filed: Jan. 13, 2014
(86) PCT No.: PCT/CN2014/070527

§ 371 Date: Feb. 12, 2014

(30) Foreign Application Priority Data
Dec. 31, 2013 (CN) 2013107538805

(51) Int. Cl. B05B 12/02; B05B 1/00; B05B 12/12; G02F 1/13; G02F 1/1333

(52) U.S. Cl. CPC B05B 12/02; G02F 1/1303; G02F 1/1333; B05B 12/12; B05B 1/005

(57) ABSTRACT

A dry etcher comprises: a reactor and an upper electrode plate and a lower electrode plate which are mounted in the reactor, a plurality of ventholes set correspondingly to the etching areas are defined in the upper electrode plate for blowing gas into the reactor; a flow controller connected to the reactor for alternately controlling the gas rates of the ventholes; some etching rate detectors mounted in the reactor for detecting the etching rates of the etching areas; a center controller electrically connected to the flow controller and the etching rate detectors respectively for obtaining etching rate of the etching areas and controlling the flow controller to adjust the gas rate of the ventholes corresponding to said etching areas while the etching areas have different etching rates, thus ensuring the etching rates of the plurality of etching areas are equal. An etching method is also provided.

### TECHNICAL FIELD

The present application relates to the etching technology of liquid crystal display substrate, and more particularly, relates to a dry etcher and an etching method of the same.

### BACKGROUND

Nowadays, in a manufacturing process of liquid crystal display panel array substrate, a method of thin-film etching includes two methods, that is, dry etching and wet etching. Dry etching is usually used for the etching of common a-Si, SiNx, SiOx and some metal films. However, gas in a reactor of the dry etcher is easily to be affected by gas exhausting of mechanical pump, thus to some degree, it influences etching uniformity; edges of a substrate have a higher etching rate than central of the substrate, thus to influence the uniformity of dry etching.

### BRIEF SUMMARY

The objective of the present application is to provide a dry etcher having well uniformity and an etching method of the dry etcher in order to overcome the existing drawback that dry etching in prior art has poor uniformity.

1. The present application provides A dry etcher for etching thin-film of a plurality of etching areas on a substrate, comprising a reactor, an upper electrode plate and a lower electrode plate are mounted in the reactor, a plurality of ventholes are defined in the upper electrode plate for blowing gas into the reactor, the plurality of ventholes are respectively set correspondingly to the plurality of etching areas; wherein,

the dry etcher further comprises:

a flow controller connected to the reactor for alternately controlling the gas rates of the plurality of ventholes;

a plurality of etching rate detectors mounted in the reactor for detecting the etching rates of the plurality of etching areas;

and a center controller electrically connected to the flow controller and the plurality of etching rate detectors respectively for obtaining the etching rate of the plurality of etching areas and for controlling the flow controller to adjust the gas rate of the ventholes corresponding to said at least two etching areas while at least two of the etching areas have different etching rates, thus ensuring the etching rates of the plurality of etching areas are equal.

In one embodiment, each of the etching rate detectors includes a thickness detector and a timer, the thickness detector is used for detecting thin-film thickness of the plurality of etching areas in a pre-set period of time, the timer is used for measuring the pre-set period of time.

In another embodiment, the upper electrode plate is square, and the plurality of ventholes includes: a center hole defined in the center of the upper electrode plate, a first set of edge holes defined in four right angles of the upper electrode plate and a second set of edge holes defined between each two of the right angles.

In this embodiment, the reactor has a cuboid shape, the upper electrode plate is mounted at the top of the reactor, and the lower electrode plate is mounted on the base of the reactor correspondingly to the upper electrode plate.

In this embodiment, a couple of baffle plates are respectively set at two opposing ends of the lower electrode plate, the couple of baffle plates are fixed on the base of the reactor for fixing the lower electrode plate.

In this embodiment, at least one aspirating hole is defined in the base of the reactor, each of the aspirating holes is defined in one side of the lower electrode plate; the aspirating hole is used for exhausting waste gas.

In this embodiment, an inner wall plate is mounted in the reactor, the inner wall plate is mounted circling the inner side wall of the reactor for enhancing strength of the reactor.

The present application provides a dry etching method of the dry etcher, comprising the following steps:

S1: when etching a thin-film on the substrate through the gas in the reactor, detecting the etching rate of the plurality of etching areas through the plurality of etching rate detectors and sending the detected results to the center controller;

S2: while the center controller determining that at least two of the etching areas have different etching rates, the center controller controlling the flow controller to adjust the gas rate of the ventholes corresponding to said at least two etching areas, thus ensuring the etching rates of the plurality of etching areas are equal.

In one embodiment, the step S1 comprises the following steps:

S11: a thickness detector detecting the film thickness of the plurality of etching areas in a pre-set period of time and sending the detected thickness values to the center controller;

S12: a timer being used to measure the pre-set period of time and sending the pre-set period of time to the center controller;

S13: the center controller figuring out the etching rate of the plurality of etching areas according to the detected thickness values and the pre-set period of time.

The present application provides a dry etching method of a dry etcher, the dry etcher is used for etching thin-film of a plurality of etching areas on a substrate, the dry etcher comprises:

a reactor;

an upper electrode plate and a lower electrode plate mounted in the reactor, a plurality of ventholes are defined in the upper electrode plate for blowing gas into the reactor, the plurality of ventholes are respectively set correspondingly to the plurality of etching areas;

a flow controller is connected to the reactor for alternately controlling the gas rates of the plurality of ventholes;

a plurality of etching rate detectors are mounted in the reactor for detecting the etching rates of the plurality of etching areas; each of the etching rate detectors includes a thickness detector and a timer, the thickness detector is used for detecting thin-film thickness of the plurality of etching areas in a pre-set period of time, the timer is used for measuring the pre-set period of time;

and a center controller electric connected to the flow controller and the plurality of etching rate detectors respectively for obtaining the etching rate of the plurality of etching areas and while at least two of the etching areas have different etching rates, controlling the flow controller to adjust gas rate of the ventholes corresponding to the at least two etching areas, thus ensuring the etching rates of the plurality of etching areas are equal;

wherein, the dry etching method comprising the following steps:

S1: etching the thin-film on the substrate through the gas in the reactor, detecting the etching rate of the plurality of etching areas by the plurality of etching rate detectors and sending the detected results to the center controller;

S2: while the center controller determining that at least two of the etching areas have different etching rates, the center controller controlling the flow controller to adjust the gas rate of the ventholes corresponding to the at least two etching areas, thus ensuring the etching rates of the plurality of etching areas are equal.

In one embodiment, the step S1 comprises the following steps:

S11: the thickness detector detecting film thickness of the plurality of etching areas in a pre-set period of time and sending the detected thickness values to the center controller;

S12: the timer being used to measure the pre-set period of time and sending the pre-set period of time to the center controller;

S13: the center controller figuring out the etching rate of the plurality of etching areas according to the detected thickness values and the pre-set period of time.

When implementing the dry etcher of the present application, the following advantageous effects can be achieved: the present application provides a plurality of etching rate detectors to detect etching rate of the thin-film of every etching area on a substrate and to send detected results to a center controller, the center controller analyzes the detected results and when there are at least two etching areas have different etching rate, the center controller controls a flow controller to adjust the gas rates of ventholes corresponding to the at least two etching areas, and thus ensuring the etching rates of the etching areas on the substrate are equal and further improving the uniformity of the etching.

### BRIEF DESCRIPTION OF THE DRAWINGS

The present application will be further described with reference to the accompanying drawings and embodiments in the following, in the accompanying drawings:

FIG. 1 is a structural schematic view of a dry etcher, according to an embodiment of the present application;

FIG. 2 is a cross-view of an upper electrode plate shown in FIG. 1.

### DETAILED DESCRIPTION OF THE PREFERRED EMBODIMENT

In order to make the technical features, the propose and the technical effect of the present application more clearly, the present application will now be described in detail with reference to the accompanying drawings and embodiments.

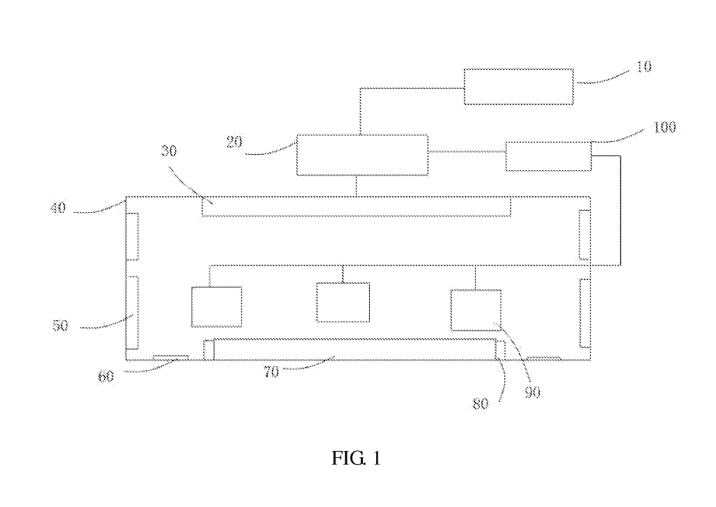

As shown in FIG. 1, the present application provides a dry etcher for etching thin-film on a substrate. The dry etcher comprises a gas chamber 10, a flow controller 20, a center controller 100, an upper electrode plate 30, a reactor 40, an inner wall plate 50, an aspirating hole 60, a lower electrode plate 70, a baffle plate 80 and a plurality of etching rate detectors 90. The reactor 40 substantially has a cuboid shape, the upper electrode plate 30 is mounted at the top of the reactor 40, and the lower electrode plate 70 is mounted on the base of the reactor 40 corresponding to the upper electrode plate 30. A couple of baffle plates 80 are respectively set at two opposing ends of the lower electrode plate 70 mounted on the base of the reactor 40, so as to clamp the lower electrode plate 70 between the couple of baffle plates 80, the way of mounting can be welding, pasting and so on. At least one aspirating hole 60 is defined in the base of the reactor 40, the aspirating hole 60 is connected to an outside mechanical pump (not shown) for exhausting waste gas and reaction products. The inner wall plate 50 is a bar-shaped folded plate, comprising four edgefolds (not shown) corresponding to the inner side wall of the reactor 40. The inner wall plate 50 is fixed on the inner side wall of the reactor 40 in welding, pasting or other manners.

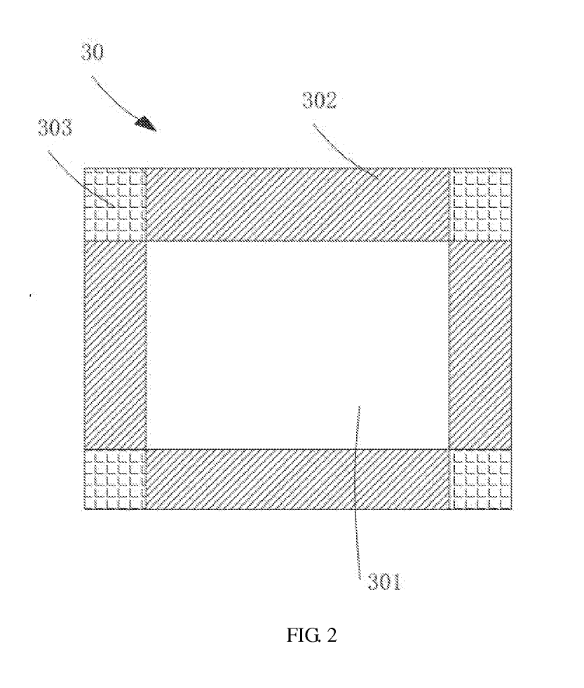

A plurality of ventholes (not shown) are defined in the upper electrode plate 30 for blowing gas into the reactor 40. As shown in FIG. 2, the upper electrode plate 30 is a square plate vertically penetrated by the ventholes. The distribution of the ventholes in the upper electrode plate 30 is as follows: a center hole 301 defined in the center of the upper electrode plate 30, a first set of edge holes 303 defined in four right angles of the upper electrode plate 30 and a second set of edge holes 302 defined between each two right angles of the upper electrode plate 30. While etching the substrate (not shown), the substrate is put onto the lower electrode plate 70 and the surface of the substrate includes a central etching area corresponding to the center hole 301 in the upper electrode plate 30, a first edge etching area corresponding to the first set of edge holes 303 in the upper electrode plate 30 and a second edge etching area corresponding to the second set of edge holes 302 in the upper electrode plate 30.

The gas chamber 10 is used for storing gas for etching the thin-film on the substrate. In order to blow gas into the reactor 40, the gas chamber 10 is connected to the ventholes respectively by pipes. The flow controller 20 is connected between the gas chamber 10 and the reactor 40 for alternately controlling the gas rates of the ventholes in the upper electrode plate 30.

In this embodiment, the dry etcher comprises three etching rate detectors 90. One etching rate detector 90 is mounted in the reactor 40 and near to the central etching area of the substrate, the other two etching rate detectors 90 are respectively mounted near to the first edge etching area and the second edge etching area of the substrate. Wherein the other two etching rate detectors 90 can be mounted in the reactor 40 by hanging or other ways and the other two etching rate detectors 90 can move up and down or move left and right under the drive of common motors or other devices. The etching rate detectors 90 are used for detecting the etching rates of the thin-film on different etching areas of the substrate in the reactor 40. Etching rate is the etching thickness of thin-film on different etching areas of substrate per unit time.

In this embodiment, each of the etching rate detectors 90 includes a thickness detector and a timer, wherein the thickness detector is used for detecting the etching thickness of the thin-film on the substrate in a pre-set period of time and the timer is used for measuring the pre-set period of time. In this embodiment, the thickness detector can choose a common thin-film thickness detecting device, such as probe-type film thickness measuring device, optics film thickness measuring device, section difference film thickness measuring device and so on. The timer also can be common timing equipment or accomplish timing by the center controller. The specific time is written by specialized film thickness measuring parameter; the film thickness is measured after implementing the parameter, then to figure out the etching rate. It is worth noting that the number of the etching rate detectors 90 can be determined by the number of the etching areas on the substrate.

The center controller 100 of the dry etcher is used for controlling every operation. In this embodiment, the center controller 100 is mounted outside of the reactor 40 and electric connected to the etching rate detectors 90 and the flow controller 20. The center controller 100 is used for obtaining the etching rate of the thin-film of the etching areas on the substrate by the etching rate detectors 90; while at least two of the etching areas have different etching rates, controlling the flow controller 20 to adjust the gas rate of the ventholes corresponding to said at least two etching areas, and thus ensuring the etching rate of the etching areas on the substrate are equal.

The present application also provides an etching method of the dry etcher, which comprises the following steps:

S1: the gas chamber 10 blowing gas into the reactor 40 through pipes and the ventholes which are defined in the upper electrode plate 30 and connected to the pipes, using the gas in the reactor 40 to etch the substrate placed on the lower electrode plate 70 in the reactor and using the plurality of etching rate detectors 90 to detect the etching rate of every etching area on the substrate; in detail, the thickness detector of the etching rate detector 90 detecting the film thickness of every etching area on the substrate in the pre-set period of time and sending the detected thickness values to the center controller 100, the timer of the etching rate detector 90 recording the pre-set period of time and sending the pre-set period of time to the center controller 100, then the center controller 100 figuring out the etching rate of the thin-film of every etching area on the substrate according to the detected thickness values and the pre-set period of time;

S2: analyzing the detected etching rate of the thin-film by the center controller 100; while the center controller 100 detecting that at least two etching areas have different etching rate, the center controller 100 controlling the flow controller 20 to adjust the gas rate of the ventholes corresponding to said at least two etching areas, and thus ensuring the etching rates of the etching areas on the substrate are equal.

In order to make the dry etching method of the present application more clearly, the present application will now be described in detail with reference to the accompanying embodiment.

Etching the thin-film A on the substrate is provided as an example. The ventholes in the upper electrode plate 30 include the center hole 301, the first set of edge holes 303 and the second set of edge holes 302. Accordingly, the etching areas of the substrate include the central etching area, the first edge etching area and the second edge etching area. While etching, firstly, the center controller 100 controls to blow equivalent gas into the center hole 301, the first set of edge holes 303 and the second set of edge holes 302 through the flow controller 20. At the moment, the thin-film etching is performed in the central etching area, the first edge etching area and the second edge etching area on the substrate within a pre-set period of time, such as 5 minutes. And the etching is stopped when the etching rate detector 90 has detected that the time is out of the pre-set period of time and the value of the pre-set period of time is sent to the center controller 100. At the same time, the thickness detectors of the etching rate detectors 90 measure the thin-film thickness of the central etching area, the first edge etching area and the second edge etching area, and send the detected thickness values of the three etching areas to the center controller 100. The center controller 100 analyzes the detected results to determine the speed of every etching area and adjusts the gas rate parameters corresponding to each of the etching areas according to the determined results. For example, the gas rate of the ventholes corresponding to the etching area with higher etching rate is reduced, so as to ensure the etching rates of the etching area are equal. In detail, the center controller 100 controls the gas rate by controlling the flow controller 20.

The present application provides a plurality of etching rate detectors to detect etching rate of the thin-film of every etching area on a substrate and to send the detected results to a center controller, the center controller analyzes the detected results and when there are at least two etching areas have different etching rate, the center controller controls a flow controller to adjust the gas rates of ventholes corresponding to the at least two etching areas, and thus ensuring the etching rates of the etching areas on the substrate are equal and further improving the uniformity of the etching.

Although the present application is illustrated with the embodiments accompanying the drawings, the present application is not limited to the above-mentioned specific embodiments, and the above-mentioned embodiments are only for illustration, not for limitation. In the inspiration of the present, those skilled in the art may make many modifications for the present application, without going beyond the purpose and the scope the claims intend to protect of the present application, such as the case cover formed integrated with the cover body, all these belong to the protection of the present application.

1. A dry etcher for etching thin-film of a plurality of etching areas on a substrate, comprising a reactor, an upper electrode plate and a lower electrode plate are mounted in the reactor, a plurality of ventholes are defined in the upper electrode plate for blowing gas into the reactor, the plurality of ventholes are respectively set correspondingly to the plurality of etching areas; wherein,
the dry etcher further comprises:
a flow controller connected to the reactor for alternately controlling the gas rates of the plurality of ventholes;
a plurality of etching rate detectors mounted in the reactor for detecting the etching rates of the plurality of etching areas;
and a center controller electrically connected to the flow controller and the plurality of etching rate detectors respectively for obtaining the etching rate of the plurality of etching areas and for controlling the flow controller to adjust the gas rate of the ventholes corresponding to said at least two etching areas while at least two of the etching areas have different etching rates, thus ensuring the etching rates of the plurality of etching areas are equal.

2. The dry etcher according to claim 1, wherein each of the etching rate detectors includes a thickness detector and a timer, the thickness detector is used for detecting thin-film thickness of the plurality of etching areas in a pre-set period of time, the timer is used for measuring the pre-set period of time.

3. The dry etcher according to claim 1, wherein the upper electrode plate is square, and the plurality of ventholes includes: a center hole defined in the center of the upper electrode plate, a first set of edge holes defined in four right angles of the upper electrode plate and a second set of edge holes defined between each two of the right angles.

4. The dry etcher according to claim 3, wherein the reactor has a cuboid shape, the upper electrode plate is mounted at the top of the reactor, and the lower electrode plate is mounted on the base of the reactor correspondingly to the upper electrode plate.

5. The dry etcher according to claim 4, wherein a couple of baffle plates are respectively set at two opposing ends of the lower electrode plate, the couple of baffle plates are fixed on the base of the reactor for fixing the lower electrode plate.

6. The dry etcher according to claim 5, wherein at least one aspirating hole is defined in the base of the reactor, each of the aspirating holes is defined in one side of the lower electrode plate; the aspirating hole is used for exhausting waste gas.

7. The dry etcher according to claim 6, wherein an inner wall plate is mounted in the reactor, the inner wall plate is mounted circling the inner side wall of the reactor for enhancing strength of the reactor.

8. A dry etching method of the dry etcher according to claim 1, wherein, comprising the following steps:
S1: when etching a thin-film on the substrate through the gas in the reactor, detecting the etching rate of the plurality of etching areas through the plurality of etching rate detectors and sending the detected results to the center controller;
S2: while the center controller determining that at least two of the etching areas have different etching rates, the center controller controlling the flow controller to adjust the gas rate of the ventholes corresponding to said at least two etching areas, thus ensuring the etching rates of the plurality of etching areas are equal.

9. The dry etching method according to claim 8, wherein, the step S1 comprises the following steps:
S11: a thickness detector detecting the film thickness of the plurality of etching areas in a pre-set period of time and sending the detected thickness values to the center controller;
S12: a timer being used to measure the pre-set period of time and sending the pre-set period of time to the center controller;
S13: the center controller figuring out the etching rate of the plurality of etching areas according to the detected thickness values and the pre-set period of time.

10. A dry etching method of a dry etcher, the dry etcher is used for etching thin-film of a plurality of etching areas on a substrate, the dry etcher comprises:
a reactor;
an upper electrode plate and a lower electrode plate mounted in the reactor, a plurality of ventholes are defined in the upper electrode plate for blowing gas into the reactor, the plurality of ventholes are respectively set correspondingly to the plurality of etching areas;
a flow controller is connected to the reactor for alternately controlling the gas rates of the plurality of ventholes;
a plurality of etching rate detectors are mounted in the reactor for detecting the etching rates of the plurality of etching areas; each of the etching rate detectors includes a thickness detector and a timer, the thickness detector is used for detecting thin-film thickness of the plurality of etching areas in a pre-set period of time, the timer is used for measuring the pre-set period of time;
and a center controller electric connected to the flow controller and the plurality of etching rate detectors respectively for obtaining the etching rate of the plurality of etching areas and while at least two of the etching areas have different etching rates, controlling the flow controller to adjust gas rate of the ventholes corresponding to the at least two etching areas, thus ensuring the etching rates of the plurality of etching areas are equal;
wherein, the dry etching method comprising the following steps:
S1: etching the thin-film on the substrate through the gas in the reactor, detecting the etching rate of the plurality of etching areas by the plurality of etching rate detectors and sending the detected results to the center controller;
S2: while the center controller determining that at least two of the etching areas have different etching rates, the center controller controlling the flow controller to adjust the gas rate of the ventholes corresponding to the at least two etching areas, thus ensuring the etching rates of the plurality of etching areas are equal.

11. The dry etching method according to claim 10, wherein, the step S1 comprises the following steps:
S11: the thickness detector detecting film thickness of the plurality of etching areas in a pre-set period of time and sending detected thickness values to the center controller;
S12: the timer being used to measure the pre-set period of time and sending the pre-set period of time to the center controller;
S13: the center controller figuring out the etching rate of the plurality of etching areas according to the detected thickness values and the pre-set period of time.
